(19) United States
(12) Patent Application Publication
(10) Pub. No.: US 2011/0316829 A1
(43) Pub. Date: Dec. 29, 2011

(54) LIQUID CRYSTAL DISPLAY DEVICE

(75) Inventors: Naoya OKA, Sendai (JP); Hiroyuki KURABAYASHI, Yokohama (JP); Yasutaka TSURU, Yokohama (JP); Kazuhiko TANAKA, Fujisawa (JP); Yuya OGI, Yokohama (JP)

(73) Assignee: Hitachi Consumer Electronics Co., Ltd.

(21) Appl. No.: 13/091,712

(22) Filed: Apr. 21, 2011

(30) Foreign Application Priority Data
Jun. 25, 2010 (JP) 2010-145008

(51) Int. Cl. G09G 3/36; G09G 5/10

(52) U.S. Cl. 345/207; 345/690; 345/102

(57) ABSTRACT

A backlight of a liquid crystal display device is divided into a plurality of regions. A backlight area dimmer sets a dimming value for each of the regions of the backlight according to a characteristic amount of the input image. A backlight dimming limiter sets an upper limit and lower limit of the dimming value set by the backlight area dimmer. In this case, the backlight dimming limiter may set the upper and lower limits of the dimming value according to a combination of at least two pieces of information among illuminance information on the external light, category information on the input image and image mode information set by the user.

### CLAIM OF PRIORITY

The present application claims priority from Japanese patent application serial No. JP 2010-145008, filed on Jun. 25, 2010, the content of which is hereby incorporated by reference into this application.

### BACKGROUND OF THE INVENTION

1. Field of the Invention

The present invention relates to a liquid crystal display device that includes a backlight for irradiating a liquid crystal panel for displaying an image with light from a back surface of the panel, in which the brightness of the backlight is controlled in response to an image signal representing the image to be displayed.

2. Description of the Related Art

In a recent liquid crystal display device, a light emitting diode (LED) that consumes low power and allows the quality of an image to be improved tends to be used as a light source of a backlight that irradiates a liquid crystal panel with light from a back surface of the panel, instead of a cold cathode fluorescent lamp (CCFL) that has been a mainstream light source. Normally, the backlight emits light with certain brightness regardless of an image signal and causes the image with predetermined brightness to be displayed by controlling light transmittance of the liquid crystal panel in response to the brightness of the image signal. Thus, even when the image is dark, the light source of the backlight consumes constant power without reducing power. Therefore, the power consumption efficiency is not good. To cope with this, the following technique has been proposed. The technique is to reduce consumption power and improve the quality of an image by making the brightness (hereinafter also referred to as luminescence) of a backlight variable and controlling, according to the level of an input image signal, the brightness of the backlight and the grayscale level of the image displayed on a liquid crystal panel. In addition, the known technique is that a backlight is divided into a plurality of regions (areas) and the brightness of the backlight is controlled for each of the regions (this technique is called area control or local dimming).

For example, a liquid crystal display device described in the first embodiment of JP-A-2008-15430 is operated as follows. The liquid crystal display device has a backlight divided into a plurality of regions, detects the grayscale levels of the brightest RGB components from RGB components of a frame of an input image signal for each of the regions, and changes the grayscale levels of the input image signal so that the grayscale levels are equal to upper limits of the grayscale levels of the RGB components. For a time period for which the backlight is turned on, the liquid crystal display device causes the backlight to blink according to duties corresponding to the ratios of the grayscale levels of the brightest RGB components to the upper limits of the grayscale levels.

### SUMMARY OF THE INVENTION

According to the area control, consumption power can be optimized for each of the areas. Thus, power consumed by the entire backlight can be minimized. However, the area control may reduce the quality of an image depending on the type of the image displayed on a screen. For example, when the entire background of the image is black and a white pattern is displayed on a part of the background, the light of the backlight leaks into the surrounding of the pattern and thereby a circular part of the black background becomes bright. This causes a deterioration in quality of the image. In addition, when such pattern moves, light that looks like an image artifact remains on the back side of the pattern. This phenomenon is called “halo” which is disadvantageous for execution of the area control.

The optimal conditions for brightness of a display screen and reduction in consumption power of a backlight vary depending on the visual environment and the type of an image. For example, when the surrounding environment is bright or when an image of a sports program is displayed, an increase in the luminescence needs to be prioritized over a reduction in power. In contrast, when the surrounding environment is dark or when an image of a movie program is displayed, the luminescence needs to be reduced and a reduction in power needs to be prioritized. In any case, it is necessary to suppress a reduction in the quality of the image (or suppress the occurrence of halo).

The present invention provides a technique capable of setting luminescence to the optimal value in accordance with a visual environment and the type of an image and suppressing a reduction (caused by halo or the like) in the quality of the image.

According to the present invention, a liquid crystal display device comprises: a liquid crystal display; and a backlight that irradiates the liquid crystal display with light, wherein the backlight is divided into a plurality of regions; and the backlight includes: a backlight area dimmer that sets a dimming value for each of the regions of the backlight according to a characteristic amount of an input image, a backlight dimming limiter that sets an upper limit and a lower limit of a dimming value in a range of the dimming value set by the backlight, and a sensor receiver that detects illuminance of external light, wherein the backlight dimming limiter changes the set upper and lower limits of the dimming value and sets either one of the limits according to illuminance information received from the sensor receiver.

The liquid crystal display device according to the present invention may preferably include an image characteristic detector that detects the category of the input image, wherein the backlight dimming limiter changes the set upper and lower limits of the dimming value and sets either one of the limits according to category information received from the image characteristic detector.

The liquid crystal display device according to the present invention may preferably include a remote control light receiver that receives an instruction from a user through a remote controller, wherein the backlight dimming limiter changes the set upper and lower limits of the dimming value and sets either one of the limits according to image mode information set by the user and received from the remote control light receiver.

The liquid crystal display device according to the present invention may preferably include the sensor receiver, the image characteristic detector, and the remote control light receiver, wherein the backlight dimming limiter changes the set upper and lower limits of the dimming value and sets either one of the limits according to a combination of at least two pieces of information among illuminance information on the external light, category information on the input image and image mode information set by the user.

According to the present invention, it is possible to set the optimal luminescence in accordance with a visual environment and the type of an image and suppress a reduction (caused by halo or the like) in the quality of the image.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a liquid crystal display device according to an embodiment of the present invention.

FIG. 2 is a diagram showing an example of divided regions of a LED backlight.

FIG. 3 is a diagram showing an example of a method for setting upper and lower limits of a dimming value for use in illuminance information.

FIG. 4 is a diagram showing a method for determining the dimming value on the basis of an image characteristic amount (APL) of each of regions.

FIG. 5 is a diagram showing a method for setting upper and lower limits of the dimming value for use in category information.

FIG. 6 is a diagram showing a method for setting upper and lower limits of the dimming value for use in mode information.

FIG. 7 is a diagram showing a method for setting upper and lower limits of the dimming value for use in a combination of the illuminance information, the category information and the mode information.

FIG. 8 is a block diagram showing a modification of the liquid crystal display device shown in FIG. 1.

FIG. 9 is a block diagram showing a modification of the liquid crystal display device shown in FIG. 8.

FIG. 10A is a diagram showing an example (still image) of a conventional display screen.

FIG. 10B is a diagram showing an example (still image) of a display screen according to the embodiment, compared with the screen shown in FIG. 10A.

FIG. 11A is a diagram showing an example (image) of a conventional display screen.

FIG. 11B is a diagram showing an example (image) of a display screen according to the embodiment, compared with the screen shown in FIG. 11A.

FIG. 12A is a diagram showing a method for setting upper and lower limits of the dimming value for each of regions so that the upper and lower limits vary depending on the region.

FIG. 12B is a diagram showing a display screen when the method shown in FIG. 12A is used.

### DESCRIPTION OF THE PREFERRED EMBODIMENTS

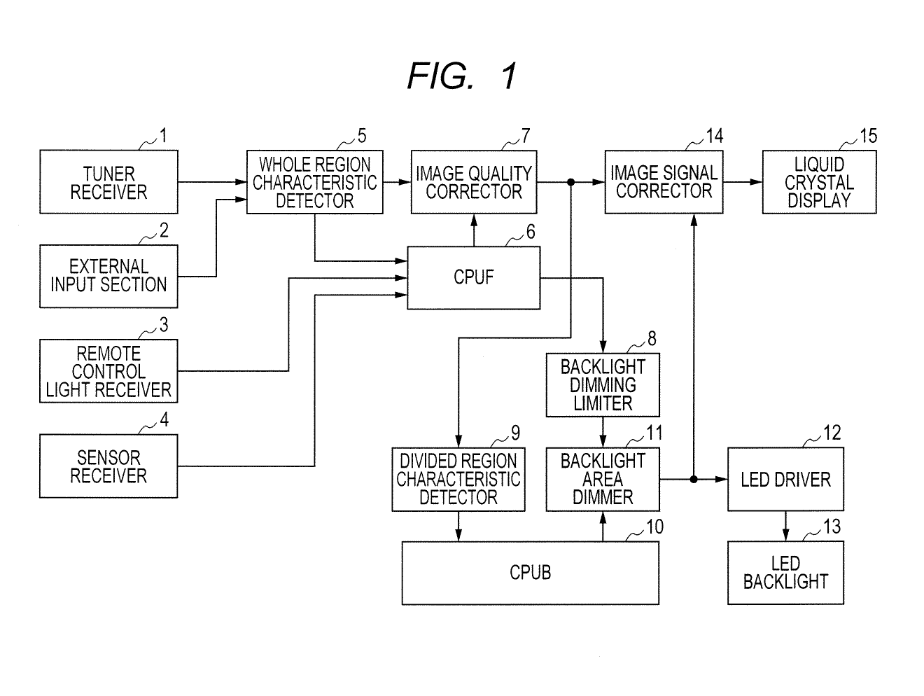

Several embodiments of the present invention are described below with reference to the accompanying drawings. FIG. 1 is a block diagram showing a liquid crystal display device according to the embodiment of the present invention. The liquid crystal display device includes a liquid crystal display 15 and an LED backlight 13. The LED backlight 13 irradiates the liquid crystal display 15 with light. The liquid crystal display device displays an image represented by an input image signal. The liquid crystal display device further includes a tuner receiver 1, an external input section 2, a remote control light receiver 3 and a sensor receiver 4 as signal input sections. The tuner receiver 1 receives a digital broadcast signal from an antenna. The external input section 2 receives an image signal from a video device or the like. The remote control light receiver 3 receives an operational instruction from a user through a remote controller. The sensor receiver 4 detects the illuminance, color and the like of external light. A whole region characteristic detector 5 detects characteristic amounts (image category information, a luminescence histogram, a chroma histogram, a hue histogram, a brightness histogram, the average luminescence (average picture level (APL)), the maximum amplitude value, the minimum amplitude value and the like) of the image from the input image signal and transmits the detected information to a first controller (CPUF) 6. For example, the category information can be easily acquired from information on a digitally broadcasted program. In addition, remote controller code information (information on an image mode set by the user) is transmitted from the remote control light receiver 3 to the CPUF 6. Furthermore, information (external light illuminance information) on the illuminance and color of the external light is transmitted from the sensor receiver 4 to the CPUF 6.

An image quality corrector 7 controls the quality of the image represented by the input image signal. A backlight dimming limiter 8 performs a process (clipping process) of limiting a variation range of a backlight dimming value. Before the clipping process, the CPUF 6 transmits an image quality correction value to the image quality corrector 7 according to the received image characteristic amounts, the received image mode information and the received external light illuminance information. In addition, before the clipping process, the CPUF 6 transmits, to the backlight dimming limiter 8, upper and lower limits of a dimming value to be used for control of the backlight. Specifically, the CPUF 6 calculates the upper and lower limits of the backlight dimming value according to at least one type of information among the image category information, the mode information and the external light illuminance information and limits a control range (variation range) of the dimming value. The image quality corrector 7 transmits the image signal to an image signal corrector 14 and the divided region characteristic detector 9. The backlight dimming limiter 8 transmits the upper and lower limits of the dimming value to the backlight area dimmer 11.

The divided region characteristic detector 9 performs area control (local dimming process). Thus, the divided region characteristic detector 9 detects characteristic amounts (a luminescence histogram, a chroma histogram, a hue histogram, a brightness histogram, the average luminescence (APL), the maximum amplitude value, the minimum amplitude value and the like) of an image for each of the divided regions and transmits the detected information to a second controller (CPUB) 10. The CPUB 10 calculates a backlight dimming value for each of the regions according to the image characteristic amounts (for example, the maximum amplitude value and the average luminescence APL)) for each of the regions. The dimming value is a light dimming rate of the light source, for example. The dimming value includes a value or data, which is proportional to the ratio of the maximum or average luminescence of an image signal for a certain region to the maximum realizable luminescence, for example. When the ratio is 50%, the dimming value is 0.5, for example. This value means that the intensity of light emitted from the light source is reduced to 50% of the maximum light intensity. The backlight area dimmer 11 performs the clipping process on the calculated dimming value using the upper and lower limits transmitted from the backlight dimming limiter 8 and determines a dimming characteristic for each of the regions. As a result, the dimming value for the backlight is ranges between the upper and lower limits.

An LED driver 12 controls the brightness of the backlight 13 by controlling the intensities of light to be emitted by LEDs included in the LED backlight 13 according to the dimming characteristics (of the regions) determined by the backlight area dimmer 11. The image signal corrector 14 corrects, according to the dimming characteristic (of each of the regions) determined by the backlight area dimmer 11, the level (grayscale value of pixels) of the image signal of the region. The liquid crystal display 15 displays the image according to the corrected level of the image signal. The level of the image signal is corrected by multiplying the level of the image signal by the calculated dimming value or the inverse of the dimming value limited by the upper or lower limit, or by amplifying the level of the image signal using the inverse of the dimming value.

The liquid crystal display device according to the embodiment sets the upper and lower limits of the backlight dimming value according to at least one of the type (category information) of an image to be displayed, the information on an image mode set by the user, and the visual environment (external light illuminance information) and limits a settable range (variation range) of the dimming value. It is, therefore, possible to set the optimal luminescence according to at least one of the visual environment and the type of the image, reduce differences between the dimming values of the regions, and suppress a reduction caused by halo (caused by the differences between the dimming values) or the like in the quality of the image.

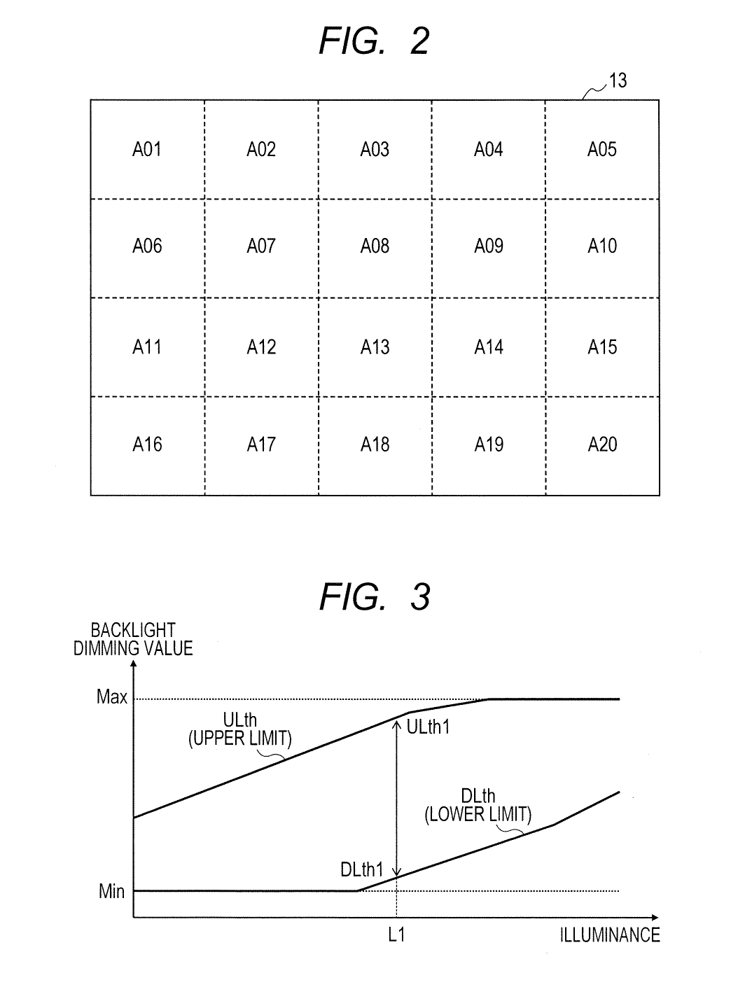

FIG. 2 is a diagram showing an example of the regions formed by dividing the LED backlight 13 in order to perform the area control. In the example, the backlight is divided into 20 regions A01 to A20, and LED light sources are provided for the regions, respectively. Dimming values of the backlight are independently set for the regions, respectively, and the intensities of light can be controlled. It is possible to more finely perform the area control and obtain a larger effect of a reduction in power by increasing the number of regions formed by dividing the backlight.

The following embodiments describe how the backlight is controlled according to at least one of the visual environment and the type of an image.

### First Embodiment

The first embodiment describes that the backlight is controlled according to information on illuminance detected by the sensor receiver 4 as the visual environment.

FIG. 3 is a diagram showing an example of a method for setting upper and lower limits ULth and DLth of the dimming value for the illuminance information. The illuminance information is acquired by causing the sensor receiver 4 to acquire the illuminance of external light. The CPUF 6 causes the backlight dimming limiter 8 to set the upper and lower limits ULth and DLth of the dimming value according to the illuminance information. For example, when the illuminance is L1, the upper limit is ULth1 and the lower limit is DLth1.

When the illuminance is high, the upper limit ULth of the backlight dimming value is allowed to be up to the maximum value Max. However, as the illuminance is reduced, the upper limit ULth is reduced from the maximum value Max. On the other hand, when the illuminance is low, the lower limit DLth is reduced to the minimum value Min. However, as the illuminance is increased, the lower limit DLth is increased from the minimum value Min. Thus, consumption power can be reduced without a uncomfortable feeling by setting the luminescence of the display screen to a high value when the external light is bright and setting the luminescence of the display screen to be a low value when the external light is dark. In addition, the difference between the upper limit ULth of the dimming value and the lower limit DLth of the dimming value is reduced even in any illuminance. Thus, it is possible to reduce the intensity of halo caused by differences between the dimming values. The amount of a reduction in the difference between the upper limit ULth and the lower limit DLth is determined in association with the contrast. When the contrast is emphasized, the amount of a reduction in the upper limit ULth or the amount of an increase in the lower limit DLth is reduced.

The following describes a method for determining a backlight dimming characteristic using the upper limit ULth and lower limit DLth of the dimming value. The divided region characteristic detector 9 detects a characteristic amount of an image for each of the regions. The CPUB 10 calculates, on the basis of the image characteristic amount detected for each of the regions, a backlight dimming value for the region. The backlight area dimmer 11 performs the clipping process on the calculated dimming value using the upper limit ULth and the lower limit DLth and determines a dimming characteristic for each of the regions.

FIG. 4 is a diagram showing a method for determining a backlight dimming value according to the image characteristic amount detected for each of the regions. In an example shown in FIG. 4, the average luminescence (APL) is used as the image characteristic amount. The APL is a value obtained by detecting grayscale levels of an input image signal for a pixel group belonging to a certain region and calculating the average value of the region.

A curved line (dotted line) 101 indicates an ideal dimming characteristic that realizes the optimal contrast. According to the ideal characteristic 101, the dimming value is in a range from the minimum value Min to the maximum value Max. The variation range of the dimming value is limited by the calculated upper and lower limits Uth and Dth of the dimming value. A solid line 102 indicates a dimming characteristic obtained by the clipping process of limiting the variation range of the dimming value so that the dimming value is in a range from the lower limit Dth to the upper limit Uth. Thus, the dimming value to be used is not out of the set range (from the lower limit Dth and the upper limit Uth). A broken line 103 indicates a dimming characteristic obtained by compressing the shape of the ideal characteristic 101 in a vertical direction so that the dimming value is in the range from the lower limit Dth to the upper limit Uth while the shape of the ideal characteristic 101 is maintained. The dimming characteristic 102 or 103 is selected to adapt for available contrast performance. In any case, the variation range of the backlight dimming value can be reduced by using the dimming characteristic 102 or 103 obtained by the clipping process. After that, the backlight dimming value that corresponds to the APL of each of the regions is calculated using the dimming characteristic 102 or 103. The intensities of light emitted by the backlight are controlled for the regions A01 to A20 shown in FIG. 2.

In the aforementioned example, the average luminescence (APL) is used as the image characteristic amount. Another characteristic amount can be used as the image characteristic amount. For example, a white area can be used as the image characteristic amount instead of the APL. The white area is the ratio of the total number of values that are detected from detected luminescence histogram data and equal to or larger than a certain threshold Wth to the number of all the regions. In addition, a black area is available as the image characteristic amount instead of the APL. The black area is the ratio of the total number of values that are detected from the detected luminescence histogram data and equal to or smaller than a certain threshold Bth to the number of all the regions. The shape of the curved line that indicates the backlight dimming value corresponding to the APL (used as the image characteristic amount) is the same as the shape of a curved line that indicates the backlight dimming value corresponding to the white area (used as the image characteristic amount). However, the shape of a curved line that indicates the backlight dimming value corresponding to the black area (used as the image characteristic amount) is mirror-reversed in the direction of the abscissa axis with respect to the shape of the curved line that indicates the backlight dimming value corresponding to the APL (used as the image characteristic amount). In this manner, a parameter can be selected from among the parameters (such as the APL, the white area and the black area) as the image characteristic amount to be used to calculate the dimming characteristic. In addition, two or more of the parameters can be used as the image characteristic amounts. Furthermore, the maximum luminescence may be used as the image characteristic amount. The curved line of the dimming characteristic in this case is the same as or similar to that shown in FIG. 4.

### Second Embodiment

The second embodiment describes that the backlight is controlled according to the category information indicating the type of an image signal received from the tuner receiver 1 or the external input section 2.

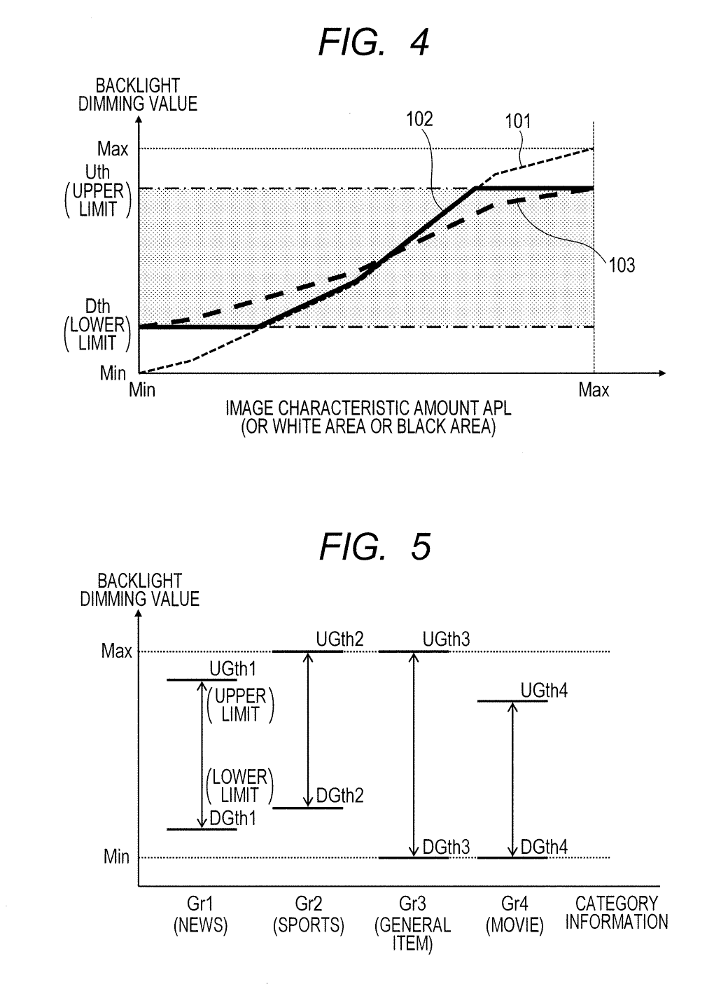

FIG. 5 is a diagram showing an example of a method for setting upper and lower limits UGth and DGth of the backlight dimming value for the category information. In the example shown in FIG. 5, the category information that can be acquired from digital broadcast or an external input is used, and the upper limit UGth and the lower limit DGth are set for each of categories. For example, when the category information is Gr2 (sports), the image is bright and the contrast is emphasized. In this case, an upper limit UGth2 for the category information Gr2 is set to the maximum value Max, and a lower limit DGth2 for the category information Gr2 is set to a value that is higher than the minimum value min. On the other hand, when the category information is Gr4 (movie), the image is soft and smooth. In this case, an upper limit UGth4 for the category information Gr4 is set to a value that is lower than the maximum value Max, and excessive contrast is not applied. The aforementioned cases are examples. Thus, the upper limit UGth and lower limit DGth of the dimming value may be set according to the information on each of the categories Gr1 to Gr4.

Subsequently, the backlight dimming value is determined for each of the regions using the upper limit UGth and the lower limit DGth in the same manner as the method shown in FIG. 4. Thus, an image quality that is suitable for the type of the image can be achieved, and it is possible to reduce the variation range of the backlight dimming value and reduce the intensity of halo that causes a reduction in the quality of the image.

### Third Embodiment

The third embodiment describes that the backlight is controlled according to the user specified mode information received from the remote control light receiver 3.

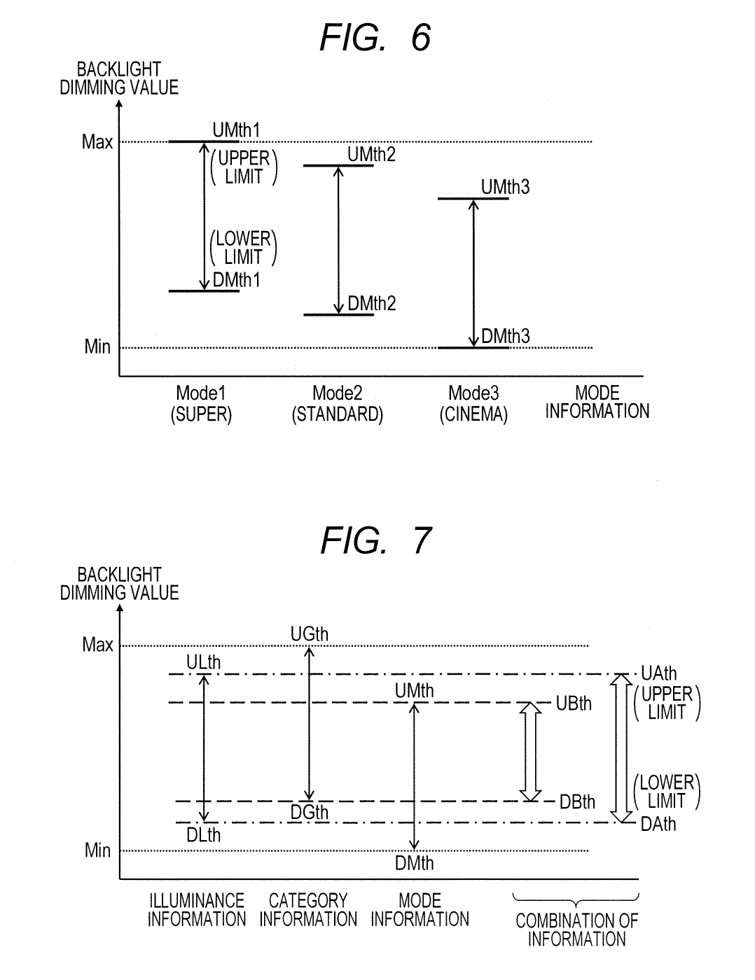

FIG. 6 is a diagram showing an example of a method for setting upper and lower limits UMth and DMth of the backlight dimming value for the mode information. The mode information is a function of changing the brightness of a image to be displayed and the quality of the image according to the user's preference. The upper limit UMth and lower limit DMth of the dimming value are set in conjunction with the mode information. For example, when the mode information indicates a mode Mode1 (super mode), the mode Mode1 is set on the assumption that the display is viewed in a bright environment. In addition, when the mode information indicates the mode Mode1, an upper limit UMth1 is set to the maximum value Max and a lower limit DMth1 is set to a higher value than the minimum value Min so that a bright image is output. On the other hand, when the mode information indicates a mode Mode3 (cinema mode), the mode Mode3 is set on the assumption that a movie is viewed in a dark environment. When the mode information indicates the mode Mode3, an upper limit UMth3 is set to a lower value than the maximum value Max and a lower limit DMth3 is set to the minimum value Min so that a soft image that is not too bright is output.

In this example, subsequently, the backlight diming value is determined for each of the regions using the upper limit UMth and the lower limit DMth in the same manner as the method shown in FIG. 4. Thus, an image quality suitable for the user specified image mode can be achieved, and it is possible to reduce the variation range of the backlight dimming value and reduce the intensity of halo that causes a reduction in the quality of the image.

### Fourth Embodiment

The fourth embodiment describes that the control described in the first to third embodiments is performed in combination. Specifically, a single pair of the upper limit Uth and lower limit Dth of the backlight dimming value are set according to the three types of the information: the illuminance information (described in the first embodiment); the category information (described in the second embodiment); and the mode information (described in the third embodiment).

FIG. 7 is a diagram showing an example of a method for setting upper and lower limits Uth and Dth of the backlight dimming value for the combination of the illuminance information, the category information and the mode information. An upper limit of the dimming value that corresponds to the illuminance information used in the first embodiment is indicated by ULth. An upper limit of the dimming value that corresponds to the category information used in the second embodiment is indicated by UGth. An upper limit of the dimming value that corresponds to the mode information used in the third embodiment is indicated by UMth. A lower limit of the dimming value that corresponds to the illuminance information used in the first embodiment is indicated by DLth. A lower limit of the dimming value that corresponds to the category information used in the second embodiment is indicated by DGth. A lower limit of the dimming value that corresponds to the mode information used in the third embodiment is indicated by DMth. A representative upper limit (UAth or UBth) and a representative lower limit (DAth or DBth) are determined according to the upper limits ULth, UGth and UMth and the lower limits DLth, DGth and DMth. Two determination methods (method A and method B) are described below.

In the method A, the upper limits ULth, UGth and UMth are averaged, and the representative upper limit UAth is calculated. In addition, in the method A, the lower limits DLth, DGth and DMth are averaged, and the representative lower limit DAth is calculated. In the method B, the minimum value of the upper limits ULth, UGth and UMth is selected as the representative upper limit UBth, and the maximum value of the lower limits DLth, DGth and DMth is selected as the representative lower limit DBth. As a result, a combination of the upper and lower limits of the dimming value, and a variation range of the dimming value, can be set, while the combination and the variation range cannot be obtained from any of the illumination information, the category information and the mode information. The backlight dimming value for each of the regions is determined using the representative upper limit (UAth or UBth) and the representative lower limit (DAth or DBth).

In this manner, the backlight can be controlled according to the combination of the three types of information, the illuminance information, the category information and the mode information so that an image can be displayed more suitably. A combination of the information to be used to control the backlight can be optionally selected. When a plurality types of information exist, at least one type of the information can be weighted and prioritized.

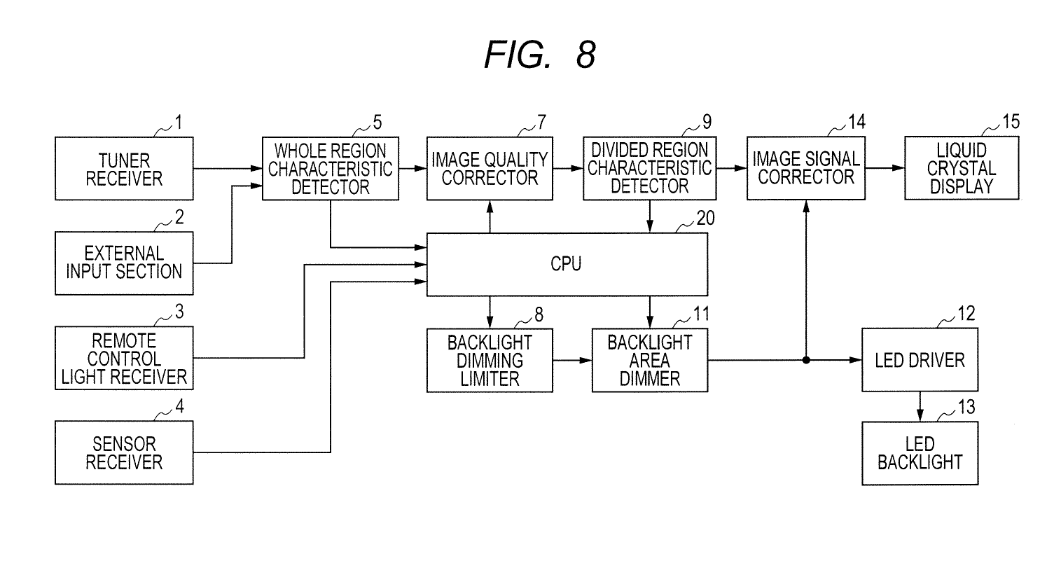

FIG. 8 is a block diagram showing a modification of the liquid crystal display device shown in FIG. 1. In the modification, a single controller (CPU) 20 is configured by integrating the first and second controllers (CPUF and CPUB). In the modification, the flow of an image signal and the flow of a process of calculating the backlight dimming value are the same as or similar to the flows described with reference to FIG. 1. However, the liquid crystal display device shown in FIG. 8 is different from the liquid crystal display device shown in FIG. 1 as follows. The divided region characteristic detector 9 detects a characteristic amount of an image for each of the regions from an image signal representing the image whose quality has been adjusted by the image quality corrector 7. Then, the divided region characteristic detector 9 transmits the image characteristic amounts to the CPU 20 again. Specifically, the characteristic amounts detected by the whole region characteristic detector 5 and the characteristic amounts detected by the divided region characteristic detector 9 are transmitted to the common CPU 20. In the modification, since the single CPU is configured by integrating the controllers, the size of a circuit can be reduced in comparison with the configuration shown in FIG. 1.

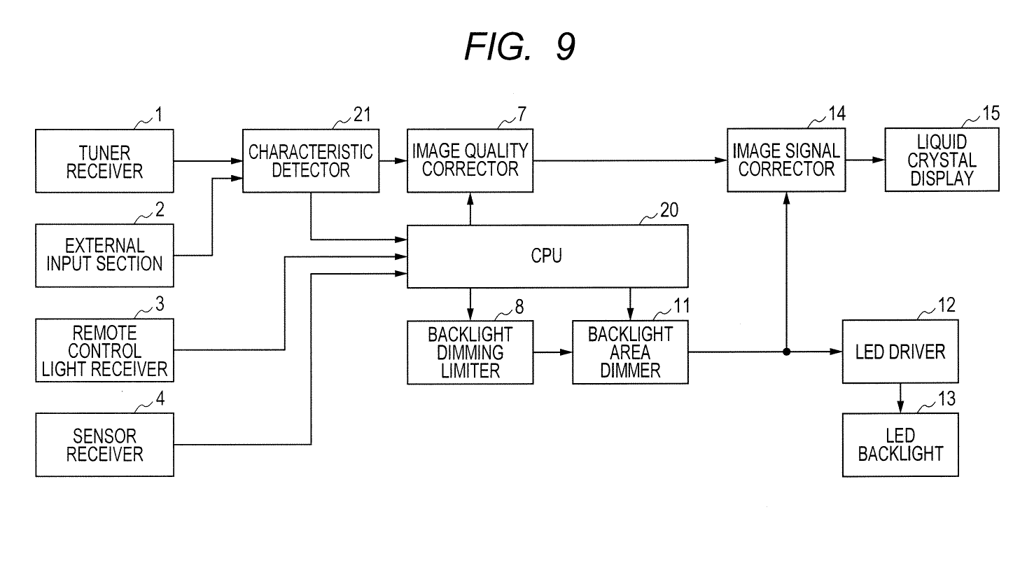

FIG. 9 is a block diagram showing a modification of the liquid crystal display device shown in FIG. 8. In the modification shown in FIG. 9, a single characteristic detector 21 is configured by integrating the whole region characteristic detector 5 shown in FIG. 8 and the divided region characteristic detector 9 shown in FIG. 8. In this modification, the flow of an image signal and the flow of a process of calculating the backlight dimming value are the same as or similar to the flows described with reference to FIGS. 1 and 8. However, the liquid crystal display device shown in FIG. 9 is different from the liquid crystal display device shown in FIG. 1 as follows. An image characteristic amount is detected by the common characteristic detector 21 for each of the regions in the same manner as the image characteristic amount of the whole region. Specifically, the image characteristic amount for each of the regions is acquired by the image quality corrector 7 from an image signal representing the image whose quality is yet to be adjusted. In order to acquire the image characteristic amount for each of the regions, a process that is the same as or similar to the processes performed by the devices shown in FIGS. 1 and 8 can be performed. In this modification, the single CPU is configured by integrating the controllers, and the single characteristic detector is configured by integrating the detectors 5 and 9. Thus, the size of a circuit can be reduced in comparison with the configuration shown in FIG. 1.

Next, effects of the aforementioned embodiments are described with reference to the drawings.

### First Example of Effects

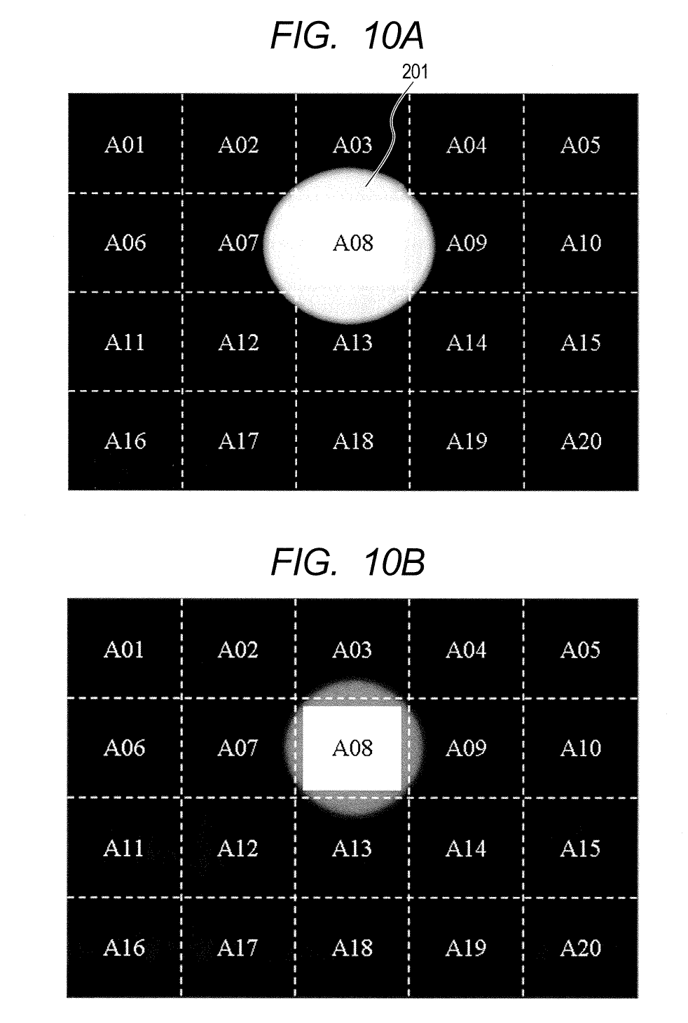

FIG. 10A is a diagram showing an example of a conventional display screen on which a black still image that includes a white window pattern at a central region A08 of the image is entirely displayed. When the image characteristic amount detected from each of the regions is the average luminescence (APL) as shown in FIG. 4, the APL detected from the region A08 is the maximum value Max, and the APLs detected from the other regions are the minimum value Min. Since the process (clipping process) of limiting a variation range of a dimming value is not performed in conventional control, a dimming characteristic is represented according to the curved line 101 shown in FIG. 4. Therefore, the backlight dimming value for the region A08 is equal to the maximum value Max, and the backlight dimming values for the other regions are equal to the minimum value Min. In this case, since light that is emitted from the backlight and reaches the region A08 leaks into a region 201 surrounding the region A08, the region 201 is slightly bright so that the quality of the image is reduced. This effect is called halo. The halo easily occurs when the difference (difference between dimming values of the backlight) between luminescence of adjacent regions is large.

FIG. 10B is a diagram showing a display screen on which an image obtained by the process (clipping process described in the aforementioned examples) of limiting a variation range of a dimming value is displayed, compared with the display screen shown in FIG. 10A. When the upper limit Uth and lower limit Dth of the dimming value are used, a dimming characteristic is represented according to the curved line 102 (or 103) shown in FIG. 4. The backlight dimming value for the region A08 is a value Uth that is lower than the maximum value Max. The backlight dimming values for the other regions are a value Dth that is higher than the minimum value Min. Thus, the difference between the dimming value for the region A08 and the dimming value for a region surrounding the region A08 is equal to the difference between the upper limit Uth and the lower limit Dth and smaller than the difference between the conventional dimming values (FIG. 10A) (maximum value Max and minimum value Min). It is, therefore, possible to suppress the occurrence of halo.

### Second Example of Effects

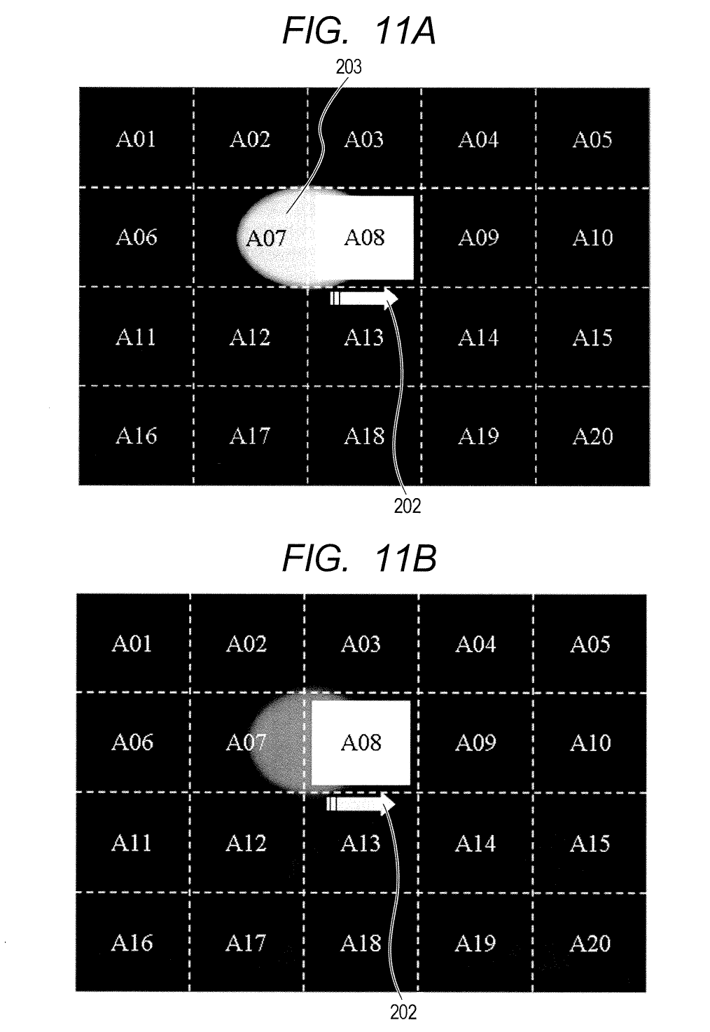

FIG. 11A is a diagram showing a conventional display screen on which an image that has the white window pattern (shown in the region A08) moving toward the right side of FIG. 11A is displayed. An arrow 202 indicates the direction in which the pattern moves. In this case, an image artifact 203 appears in a region A07 located on the opposite side of the side toward which the pattern moves. This effect is caused by the difference (difference between dimming values of the backlight) between luminescence of adjacent regions and easily occurs in the region A07 located on the back side of the moving pattern.

FIG. 11B is a diagram showing a display screen on which an image obtained by the process (described in the embodiment) of limiting a variation range of a dimming value is displayed, compared with the screen shown in FIG. 11A. In this case, when the upper limit Uth and lower limit Dth of the dimming value are used, the difference between the dimming value for the region A08 and the dimming value for the region A07 located on the back side of the region A08 is reduced to the difference between the upper limit Uth and the lower limit Dth so that remarkable image artifact hardly occurs.

### Third Example of Effects

In the first and second examples of the effects, the process (clipping process) of limiting a variation range of a dimming value is performed on the entire screen. As a result, the difference between backlight dimming values for regions for which the process of limiting variation ranges of the dimming values is performed is smaller than the difference between backlight dimming values for regions for which the process of limiting variation ranges of the dimming values is not performed. Thus, the contrast of the entire screen tends to be slightly reduced. When the process of limiting a variation range of a dimming value is performed on a part of the screen in consideration of the aforementioned effect of slightly reducing the contrast, the occurrences of halo and an image artifact can be reduced without a reduction in the contrast. In other words, the upper and lower limits of the backlight dimming value are set and vary for each of the regions. In this case, the upper and lower limits of the dimming values for the regions are determined using correlations of luminescence of adjacent regions.

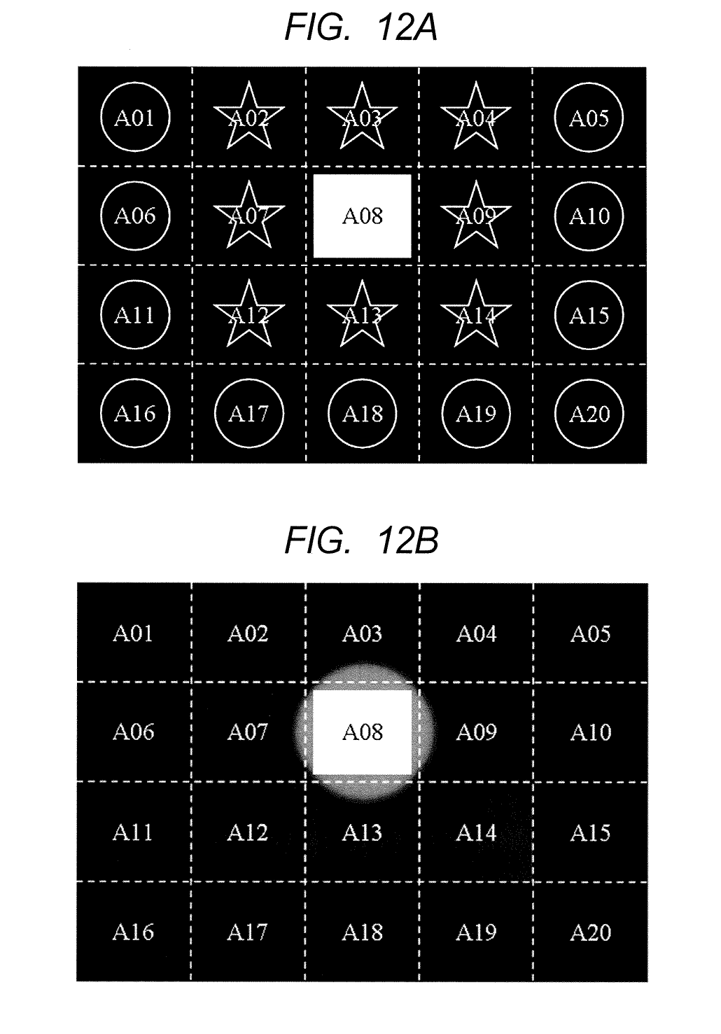

FIG. 12A is a diagram showing a method for setting upper and lower limits of the dimming value for each of the regions. When characteristic amounts (luminescence) are detected from the regions A01 to A20, the characteristic amount of the region A08 is compared with the characteristic amounts of regions (indicated by star-shaped symbols) surrounding the region A08, for example. Then, weighting is performed according to the differences between the luminescence. In this manner, an upper limit Uth′ and lower limit Dth′ of the backlight dimming value are determined. In this case, since differences between the luminescence of the adjacent regions indicated by the star-shaped symbols are large, the dimming values for the regions are weighted. The upper limit Uth′ and the lower limit Dth′ are determined by the process (clipping process) of limiting the dimming value according to the upper and lower limits Uth and Dth shown in FIG. 4. On the other hand, since differences between the luminescence of regions (indicated by circles) located far from the region A08 are small, the dimming values for the regions are not weighted (or are slightly weighted). Thus, the upper limit Uth′ is set to the maximum value Max shown in FIG. 4, (or set to an intermediate value) and the lower limit Dth′ is set to the minimum value Min shown in FIG. 4 (or set to an intermediate value).

FIG. 12B is a diagram showing a display screen obtained by setting the dimming values described with reference to FIG. 12A. Differences between the dimming value for the region A08 and dimming values for the regions indicated by the star-shaped symbols are reduced by setting the lower limit of the dimming values to the value Dth so that the occurrence of halo can be suppressed. In addition, the lower limit of the dimming values is set to the minimum value Min for the regions indicated by the circles so that differences between the dimming value for the region A08 and the dimming values for the regions indicated by the circles are large. Thus, the contrast of the entire screen is improved and consumption power can be reduced.

What is claimed is:

1. A liquid crystal display device comprising:
a liquid crystal display; and
a backlight that irradiates the liquid crystal display with light,
wherein the backlight is divided into a plurality of regions; and
the backlight is provided with:
a backlight area dimmer that sets a dimming value for each of the regions of the backlight according to a characteristic amount of an input image; and
a backlight dimming limiter that sets an upper limit and a lower limit of a dimming value in a range of the dimming value set by the backlight.

2. The liquid crystal display device according to claim 1, further comprising a sensor receiver that detects illuminance of external light,
wherein the backlight dimming limiter changes the set upper and lower limits of the dimming value and sets either one of the limits according to illuminance information received from the sensor receiver.

3. The liquid crystal display device according to claim 1, further comprising an image characteristic detector that detects the category of the input image,
wherein the backlight dimming limiter changes the set upper and lower limits of the dimming value and sets either one of the limits according to category information received from the image characteristic detector.

4. The liquid crystal display device according to claim 1, further comprising a remote control light receiver that receives an instruction from a user through a remote controller,
wherein the backlight dimming limiter changes the set upper and lower limits of the dimming value and sets either one of the limits according to image mode information set by the user and received from the remote control light receiver.

5. A liquid crystal display device including a liquid crystal display and a backlight that irradiates the liquid crystal display with light, the backlight being divided into a plurality of regions, comprising:
a backlight area dimmer that sets a dimming value for each of the regions of the backlight according to a characteristic amount of an input image;
a backlight dimming limiter that sets an upper limit and a lower limit of a dimming value in a range of the dimming value set by the backlight;
a sensor receiver that detects illuminance of external light;
an image characteristic detector that detects the category of the input image; and
a remote control light receiver that receives an instruction from a user through a remote controller, and
wherein the backlight dimming limiter changes the set upper and lower limits of the dimming value and sets either one of the limits according to a combination of at least two pieces of information among illuminance information on the external light, category information on the input image and image mode information set by the user.

6. A liquid crystal display device including a liquid crystal display and a backlight that irradiates the liquid crystal display with light, the backlight being divided into a plurality of regions, comprising:
a backlight area dimmer that sets a dimming value for each of the regions of the backlight according to a characteristic amount of an input image; and
a controller that controls a variation range of the dimming value by controlling an upper or lower limit of the dimming value according to at least one type of information among illuminance information on external light, category information on the input image, and/or image mode information set by a user.
